(19) United States
(12) Patent Application Publication
(10) Pub. No.: US 2025/0028530 A1
(43) Pub. Date: Jan. 23, 2025

(54) TECHNIQUES FOR CONTROLLING VECTOR PROCESSING OPERATIONS

(71) Applicant: Arm Limited, Cambridge (GB)

(72) Inventors: Mbou Eyole, Soham (GB); Michael Alexander Kennedy, Cambridge (GB); Giacomo Gabrielli, Cambridge (GB)

(73) Assignee: Arm Limited, Cambridge (GB)

(21) Appl. No.: 18/711,220

(22) PCT Filed: Oct. 18, 2022
(86) PCT No.: PCT/GB2022/052649

§ 371 Date: May 17, 2024

(30) Foreign Application Priority Data
Nov. 25, 2021 (GB) 2117039.4

(51) Int. Cl. G06F 9/30; G06F 15/82

(52) U.S. Cl. CPC G06F 9/30036; G06F 9/3016; G06F 15/82

(57) ABSTRACT

There is provided a processing apparatus comprising decoder circuitry. The decoder circuitry is configured to generate control signals in response to an instruction. The processing apparatus further comprises processing circuitry which comprising a plurality of processing lanes. The processing circuitry is configured, in response to the control signals, to perform a vector processing operation in each processing lane of the plurality of processing lanes for which a per-lane mask indicates that processing for that processing lane is enabled. The processing apparatus further comprises control circuitry to monitor each processing lane of the plurality of processing lanes for each instruction of a plurality of instructions performed in the plurality of processing lanes and to modify the per-lane mask for a processing lane of the plurality of processing lanes in response to a processing state of the processing lane meeting one or more predetermined conditions.

The present techniques provide a processing apparatus, a method of operating a processing apparatus and a non-transitory computer-readable medium to store computer-readable code for fabrication of a processing apparatus.

Some data processing apparatuses are provided with a plurality of processing lanes to enable vector processing operations to be performed. In some workflows that utilise vector processing operations, it can be desirable to perform vector processing operations in only a subset of the plurality of processing lanes.

In some configurations there is provided a processing apparatus comprising:
decoder circuitry configured to generate control signals in response to an instruction;
processing circuitry comprising a plurality of processing lanes, wherein the processing circuitry is configured, in response to the control signals, to perform a vector processing operation in each processing lane of the plurality of processing lanes for which a per-lane mask indicates that processing for that processing lane is enabled; and
control circuitry to monitor each processing lane of the plurality of processing lanes for each instruction of a plurality of instructions performed in the plurality of processing lanes and to modify the per-lane mask for a processing lane of the plurality of processing lanes in response to a processing state of the processing lane meeting one or more predetermined conditions.

In some configurations there is provided a method of operating a processing apparatus comprising processing circuitry comprising a plurality of processing lanes, the method comprising:
generating control signals in response to an instruction;
performing, in response to the control signals, a vector processing operation using the processing circuitry in each processing lane of the plurality of processing lanes for which a per-lane mask indicates that processing for that processing lane is enabled; and
monitoring each processing lane of the plurality of processing lanes for each instruction of a plurality of instructions performed in the plurality of processing lanes and to modify the per-lane mask for a processing lane of the plurality of processing lanes in response to a processing state of the processing lane meeting one or more predetermined conditions.

In some configurations there is provided a non-transitory computer-readable medium to store computer-readable code for fabrication of a processing apparatus comprising:
decoder circuitry configured, in response to an instruction, to generate control signals;
processing circuitry comprising a plurality of processing lanes, wherein the processing circuitry is configured, in response to the control signals, to perform a vector processing operation in each processing lane of the plurality of processing lanes for which a per-lane mask indicates that processing for that processing lane is enabled; and
control circuitry to monitor each processing lane of the plurality of processing lanes for each instruction of a plurality of instructions performed in the plurality of processing lanes and to modify the per-lane mask for a processing lane of the plurality of processing lanes in response to a processing state of the processing lane meeting one or more predetermined conditions.

The present techniques will be described further, by way of example only, with reference to configurations thereof as illustrated in the accompanying drawings, in which:

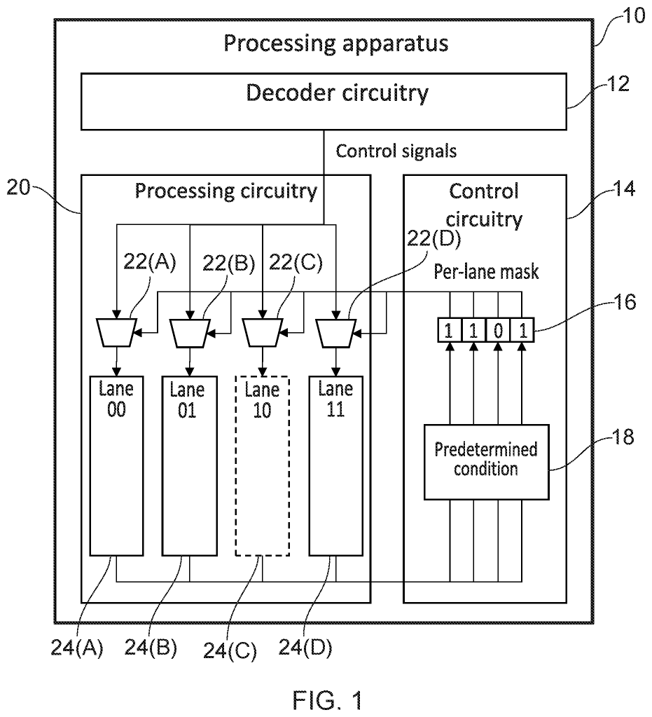

FIG. 1 schematically illustrates a processing apparatus according to various configurations of the present techniques;

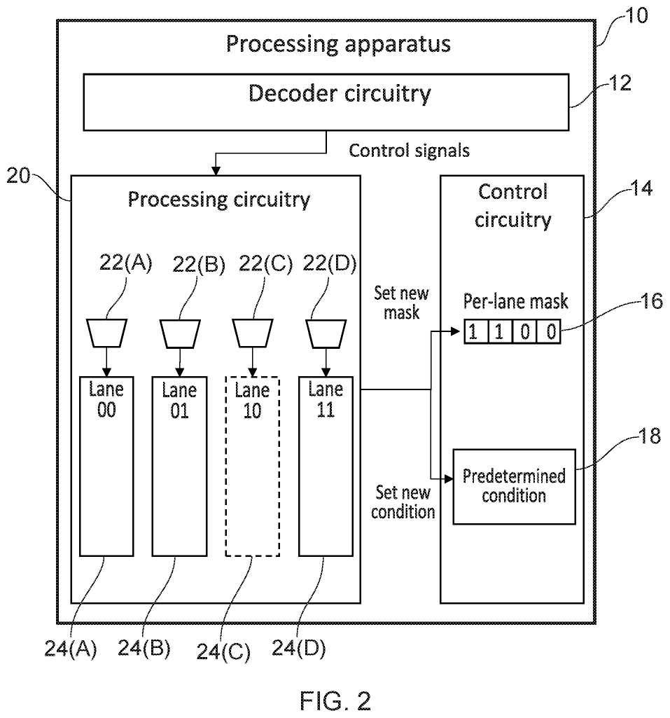

FIG. 2 schematically illustrates a processing apparatus according to various configurations of the present techniques;

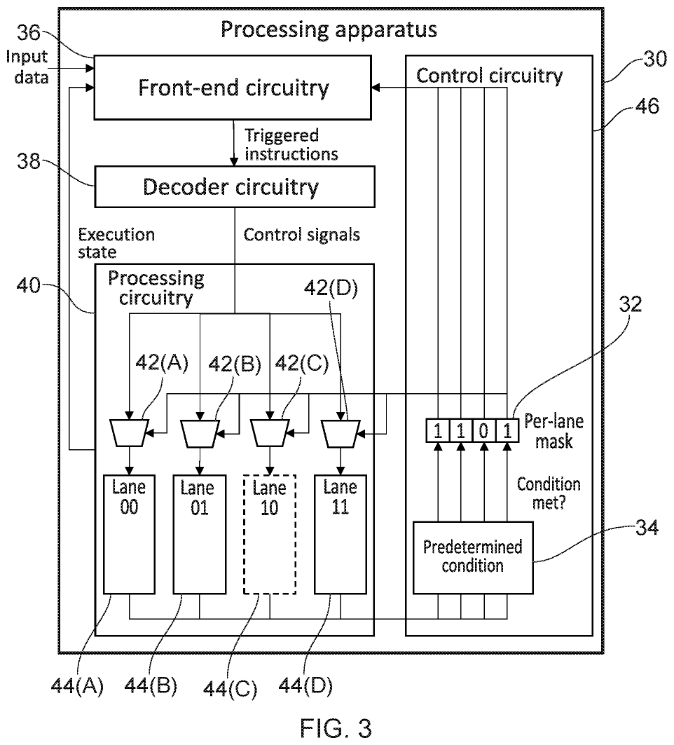

FIG. 3 schematically illustrates a processing apparatus according to various configurations of the present techniques;

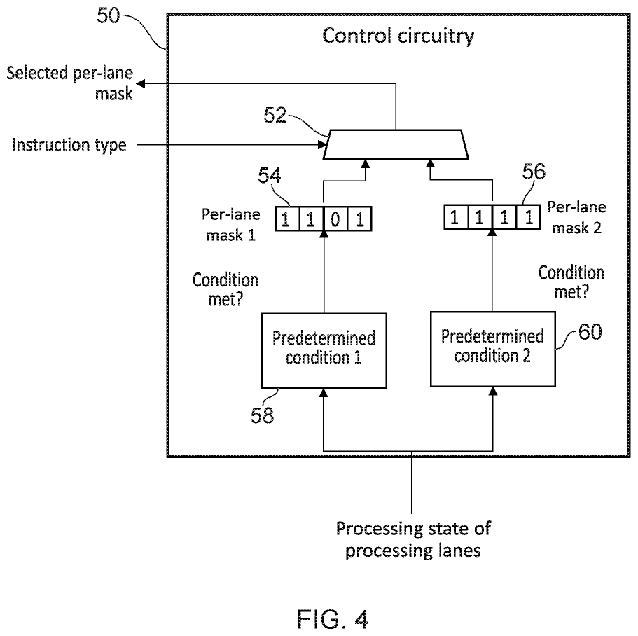

FIG. 4 schematically illustrates details of control circuitry of a processing apparatus according to various configurations of the present techniques;

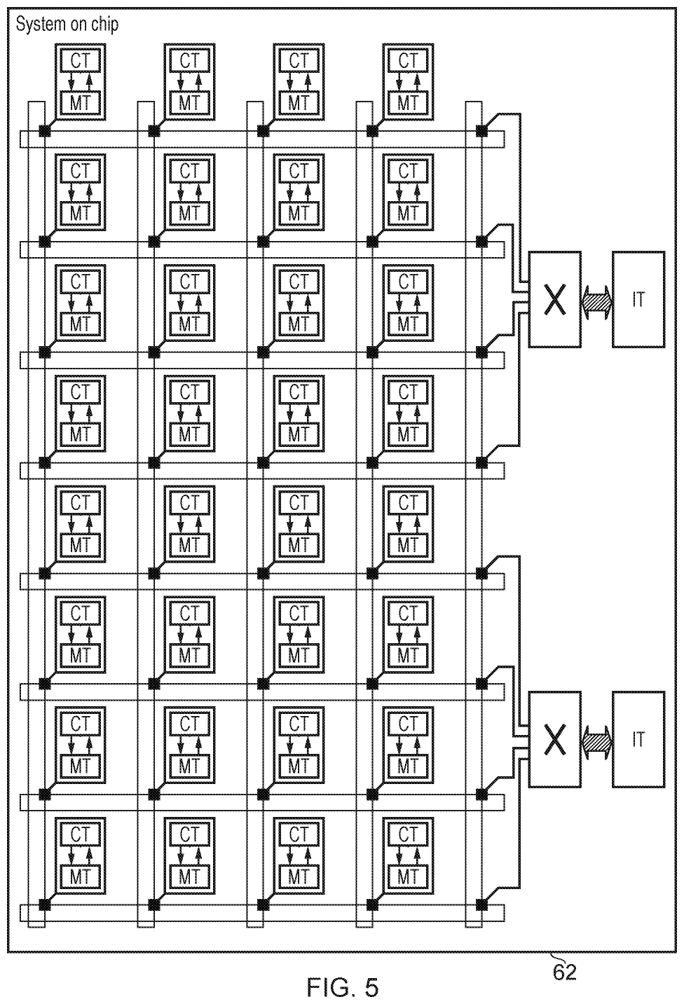

FIG. 5 schematically illustrates a spatial architecture with processing elements according to various configurations of the present techniques;

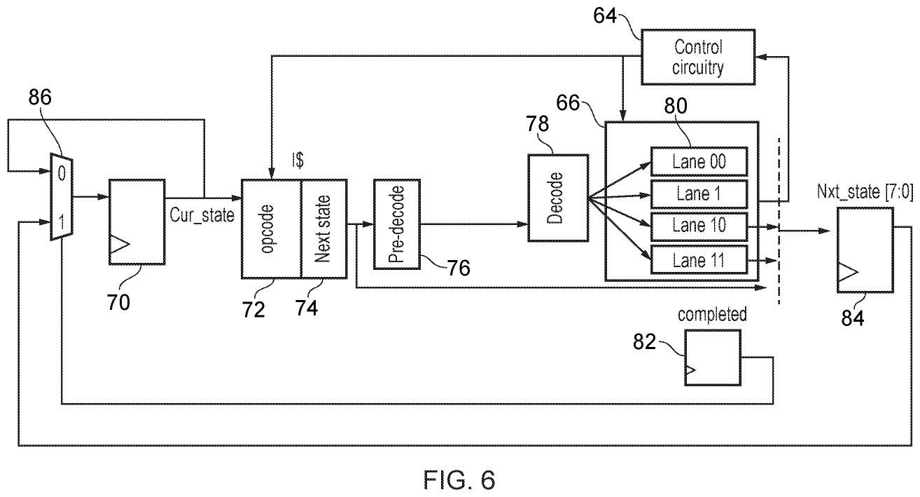

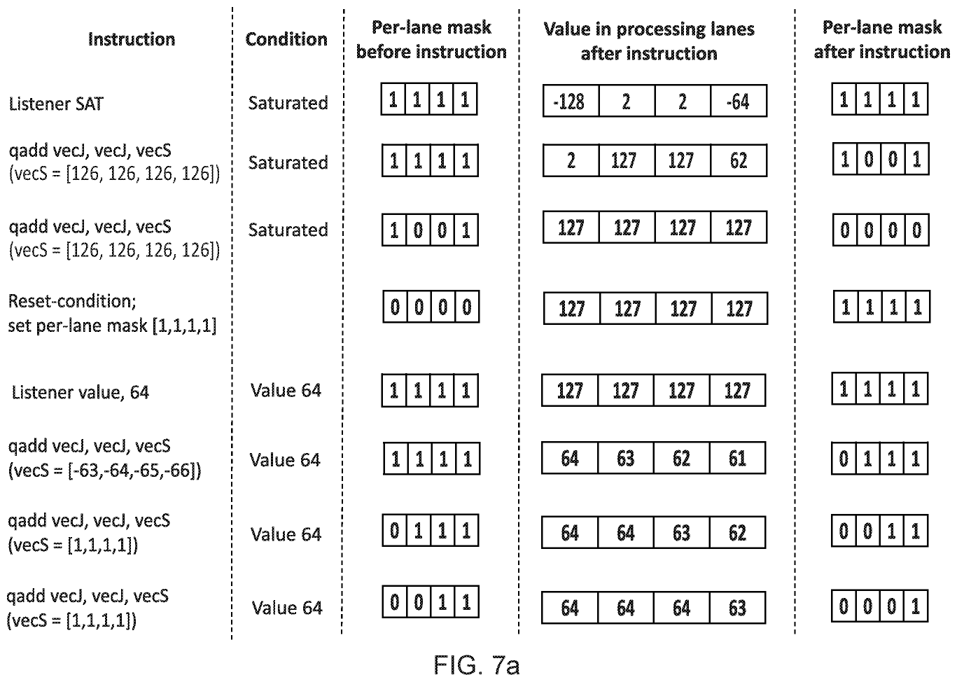

FIG. 6 schematically illustrates a triggered processing element according to various configurations of the present techniques;

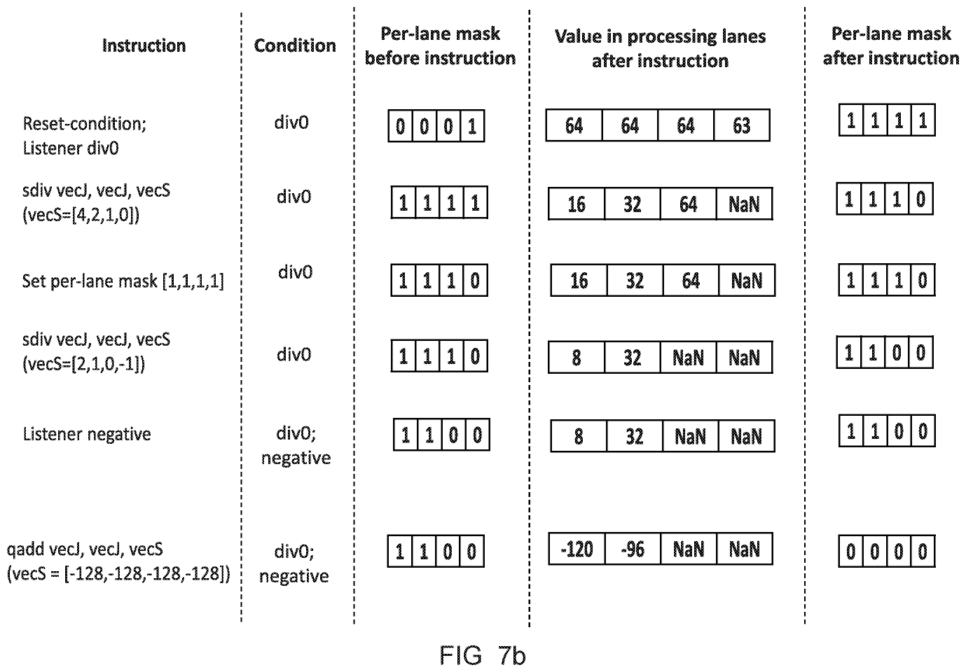

FIG. 7a schematically illustrates a sequence of processing steps according to various configurations of the present techniques;

FIG. 7b schematically illustrates a sequence of processing steps according to various configurations of the present techniques;

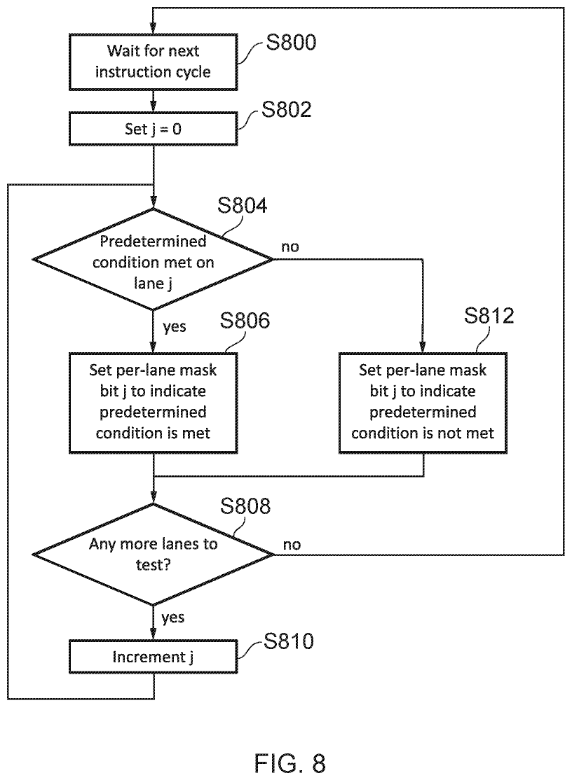

FIG. 8 schematically illustrates a sequence of steps carried out according to various configurations of the present techniques;

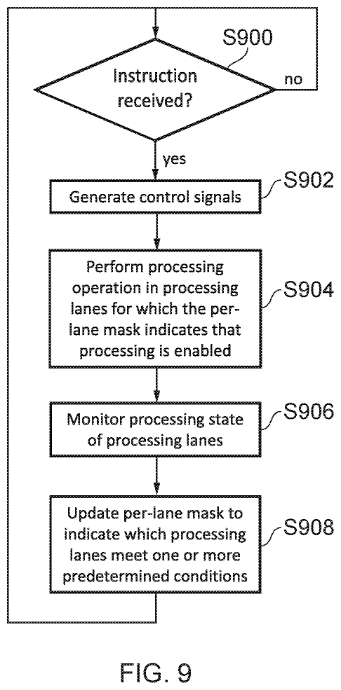

FIG. 9 schematically illustrates a sequence of steps carried out according to various configurations of the present techniques; and

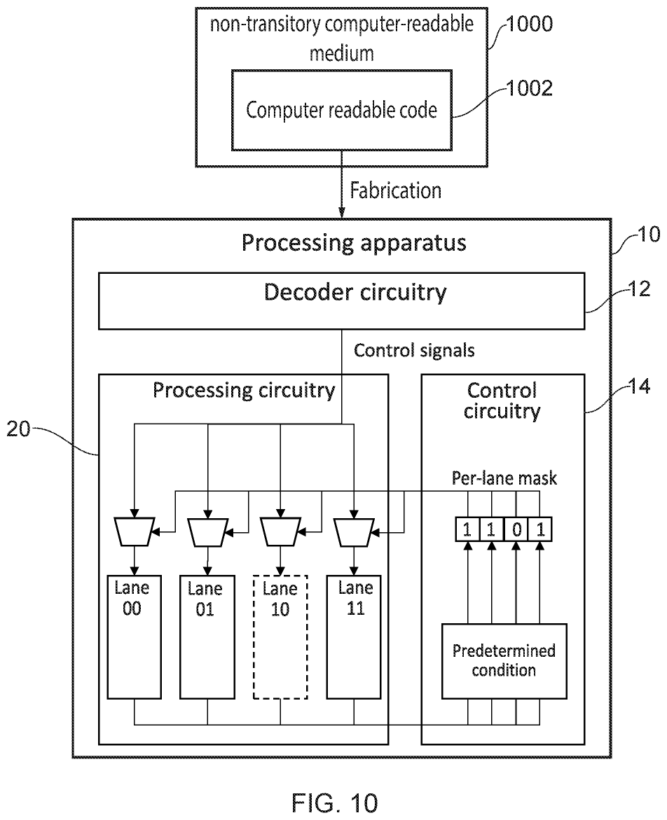

FIG. 10 schematically illustrates the fabrication of a processing apparatus according to various configurations of the present techniques.

At least some configurations provide a processing apparatus comprising decoder circuitry. The decoder circuitry is configured to generate control signals in response to an instruction. The processing apparatus further comprises processing circuitry which comprises a plurality of processing lanes. The processing circuitry is configured, in response to the control signals, to perform a vector processing operation in each processing lane of the plurality of processing lanes for which a per-lane mask indicates that processing for that processing lane is enabled. The processing apparatus further comprises control circuitry to monitor each processing lane of the plurality of processing lanes for each instruction of a plurality of instructions performed in the plurality of processing lanes and to modify the per-lane mask for a processing lane of the plurality of processing lanes in response to a processing state of the processing lane meeting one or more predetermined conditions.

In some configurations the processing circuitry, decoder circuitry, and control circuitry are each provided as distinct (discrete) functional circuits. However, in some configurations two or more of the processing circuitry, the decoder circuitry, and the control circuitry are provided as a same block of circuitry that is arranged to function as the two or more circuits. The decoder circuitry is provided to interpret a particular set of instructions that form an instruction set architecture. The instruction set architecture is a complete set of instructions that are available to a programmer to enable the programmer to control the processing circuitry. The decoder circuitry is provided to recognise each instruction of the instruction set architecture and to generate the necessary control signals to cause the processing circuitry to perform a particular operation in response to that instruction. The processing apparatus is provided with a plurality of processing lanes to enable it to perform vector processing operations. Typically, in such processing apparatuses, the same operation will be performed in each of the processing lanes using different data that is provided in vector processing registers. In this way the total throughput of the processing apparatus is increased. In some workflows it may be desirable to perform processing in each of the processing lanes. However, in other workflows, it may be desirable to control which of the processing lanes performs the processing operation on a per-lane basis. In other words, it may be desirable to control which processing lanes of the plurality of processing lanes perform a particular operation and which processing lanes of the plurality of processing lanes do not perform the particular operation.

The per-lane control of an operation can be performed, for example, by adding additional operations to set a per-lane mask and explicitly providing that per-lane mask, as an additional input, to specifically designed instructions that will then only perform that operation in processing lanes of the plurality of processing lanes for which the mask indicates that processing should be performed. The inventors of the present techniques have realised that it is not always desirable to set and provide an explicit per-lane mask each time such control is required because such an approach can add significant control overheads that result in reduced performance.

Instead, the present techniques provide control circuitry that monitors each processing lane of the plurality of processing lanes for each of a plurality of instructions that are performed in the plurality of processing lanes. In other words, the control circuitry is continually monitoring the processing lanes for the duration of at least a plurality of (two or more) instructions. The control circuitry is arranged to monitor the processing lanes to determine whether or not a processing state of that processing lane meets one or more predetermined conditions. In other words, for each individual processing lane, the control circuitry will determine whether or not processing within that lane should be performed for each instruction of a plurality of instructions based on whether or not a current processing state of the processing lane meets the one or more predetermined conditions. In this way, the processing apparatus can be arranged to disable each processing lane when that processing lane meets the one or more predetermined conditions and to only continue to perform processing operations in the remaining lanes of the plurality of processing lanes. Advantageously, the control circuitry eliminates the need to explicitly set and provide a per-lane mask for each instruction that is processed by the processing circuitry and, hence, the control overhead associated with such a technique is reduced.

The type of the processing apparatus to which the present techniques are applied is not particularly limited. In some configurations, the processing apparatus is an in-order processing apparatus that processes instructions in program counter order. In other configurations the processing apparatus is an out-of-order processing apparatus for which processing operations are provided with an original program counter order defined by the programmer or compiler. However, the out-of-order processing apparatus can deviate from the original program counter order based on a run-time availability of operands associated with the processing instructions. In some configurations the instruction is a triggered instruction; and the processing apparatus is a triggered processing apparatus comprising front-end circuitry to process a plurality of retrieved instructions and to generate the triggered instruction in response to an execution state of the processing circuitry meeting a trigger condition associated with one of the retrieved instructions. In such processing apparatuses there is no concept of a program counter. Instead each instruction is triggered in response to a preceding instruction setting the execution state of the processor such that the execution state meets the trigger condition associated with that instruction. In other words, rather than having a predetermined program order (that, in the case of an out-of-order processing apparatus, may change at runtime) the execution order of instructions of the triggered processing apparatus is not determined until runtime. The combination of a triggered processing apparatus with the control circuitry to monitor each processing lane provides a particularly flexible processing apparatus where the order in which instructions are processed and the lanes that perform the processing operations are determined at runtime in response to the processing state of the processing circuitry and the execution state of the processing circuitry.

In some configurations the front-end circuitry is configured, in response to a determination that two or more retrieved instructions of the plurality of retrieved instructions meet a trigger condition at a given time, to determine a priority order of the two or more retrieved instructions based on a number of enabled processing lanes associated with each of the two or more retrieved instructions. Because the triggered processing apparatus has no predetermined execution order for the instructions, it is possible that plural instructions are triggered in response to a same execution state. In such a situation, the triggered processing apparatus is configured to determine a priority order for the plural triggered instructions based on a number of enabled processing lanes for each of the plural triggered instructions. For example, in response to completion of a preceding instruction, the execution state of the triggered processing apparatus may indicate that two instructions are ready for execution. However, the processing state associated with one triggered instruction may indicate that only a subset of the processing lanes is to be utilised whilst the processing state associated with the other triggered instruction may indicate that all the processing lanes are to be utilised. The front-end circuitry is configured to use this information to determine the priority order associated with the instructions. In some configurations, the front-end circuitry is configured to prioritise the triggered operation that utilises the fewest lanes first. This approach may result in a reduction in overall power consumption for situations in which the result of the triggered operation reduces a number of lanes that are utilised by the other processing operation. In some alternative configurations, the front-end circuitry prioritises the processing operation for which the fewest changes to the per-lane mask are required to minimise the enabling/disabling of processing lanes. In other alternative configurations, the front-end circuitry prioritises triggered instructions for which the execution state indicates that more lanes of the plurality of processing lanes will be enabled in order to provide maximum utilisation of the channels.

In addition to the use of the processing state to determine the order in which the triggered operations are performed, in some configurations the front-end circuitry is configured to determine the priority order based on a length of time for which the trigger condition of the two or more retrieved instructions has been satisfied. This approach ensures that a balance is struck between meeting performance and/or power consumption requirements and ensuring fairness between different triggered instructions which may not best utilise the processing circuitry according to the performance and/or power consumption requirements.

The arrangement of the processing apparatus is not particularly limited. In some configurations the processing apparatus may be a single core processing apparatus or a multi-core processing apparatus. In some configurations the processing apparatus comprises a plurality of processing elements arranged to form a spatial architecture; and the decoder circuitry, the control circuitry, and the processing circuitry are arranged in a processing element of the plurality of processing elements. In other words, each processing element of the plurality of processing elements is arranged to provide decoder circuitry, processing circuitry and control circuitry that are dedicated to that processing element. The processing elements of the spatial architecture are distributed throughout a single chip in order to best utilise circuit area and to ensure locality of the processing elements to on chip storage that is associated with the processing elements.

The arrangement of the processing elements of the spatial architecture is not limited and the network connecting the processing elements can be arranged to form an N-dimensional network in which each processing element is connected to nearby processing elements along N different network paths. In some configurations the plurality of processing elements is connected via a two dimensional network arranged as a two-dimensional torus. The number of dimensions associated with the network is not restricted by a number of dimensions associated with the physical placement of components on a chip. Rather, the number of dimensions of the network is defined by a layout of connections between processing elements. In the two-dimensional network each processing element is connected in a topological equivalent of a sequence of rows and columns with processing element P_{i,j} connected between elements P_{i-1,j}, P_{i+1,j}, P_{i,j-1}, and P_{i,j+1}. Arranging the network connections to form a two-dimensional torus results in a particularly efficient configuration in which data can be routed between the processing elements whilst avoiding network bottlenecks associated with edge elements of the network. The two-dimensional torus layout is achieved by arranging an array of size R by S such that processing element P_{i,j} (1<i<R; 1<j<S) are connected between elements P_{i-1,j}, P_{i+1,j}, P_{i,j-1}, and P_{i,j+1}; elements P_{i,j} (1<j<S) are connected between elements P_{R,j}, P_{2,j}, P_{i,j-1}, and P_{i,j+1}; elements P_{R,j} (1<j<S) are connected between elements P_{R-1,j}, P_{1,j}, P_{R,j-1}, and P_{R,j+1}; elements P_{i,1} (1<i<R) are connected between elements P_{i-1,1}, P_{i+1,1}, elements P_{i,S}, and P_{i,2}; P_{i,S} (1<i<R) are connected between elements P_{i-1,S}, P_{i+1,S}, P_{i,S-1}, and P_{i,1}; element P_{1,1} is connected to P_{R,1}, P_{2,1}, P_{1,S}, and P_{1,2}; element P_{1,S} is connected to P_{R,S}, P_{2,S}, P_{1,S-1}, and P_{1,1}; element P_{R,1} is connected to P_{R-1,1}, P_{1,1}, P_{R,S}, and P_{R,2}; and element P_{R,S} is connected to P_{R-1,S}, P_{1,S}, P_{R,S-1}, and P_{R,1}. The two-dimensional torus layout provides the advantage that no processing elements are located on the edge of the network resulting in a more equal distribution of network bandwidth.

The one or more predetermined conditions are not necessarily fixed and in some configurations the decoder circuitry is responsive to an update-condition instruction specifying a new condition to generate update-condition control signals; and the processing circuitry is configured, in response to the update-condition control signals, to set the new condition as one of the one or more predetermined conditions. In some configurations the decoder circuitry is responsive to the update-condition instruction specifying whether the new condition is to be added as an additional condition of the one or more predetermined conditions or is to replace the existing one or more predetermined conditions. In some configurations the control circuitry is configured to modify the per-lane mask in response to any of the one or more predetermined conditions being met. In other configurations the control circuitry is configured to modify the per-lane mask in response to a logical combination of the one or more predetermined conditions being met.

The one or more predetermined conditions can be variously defined. However, in some configurations the control circuitry is configured to modify the per-lane mask in order to meet an energy consumption target. In some configurations there is there a non-linear relationship between the performance gained by enabling more lanes and the power consumed by the additional lanes which can be substantially more as the number of lanes increases. In such cases, and where performance is not of primary importance, the control circuitry can improve efficiency by reducing the number of lanes that are enabled. For example, rather than performing a single operation using all the lanes of the plurality of processing lanes, the control circuitry could disable half of the lanes of the plurality of processing lanes resulting in a requirement that two operations are performed. However, due to the non-linear power requirements of the lanes, the amount of power used by each of the two operations is less than half of the amount of power that would have been used if all of the lanes had been enabled. Hence, an overall energy reduction can be achieved.

In some configurations the one or more predetermined conditions comprises a saturation condition, and the control circuitry is configured to modify the per-lane mask in response to the processing state of the processing lane indicating that a value in the processing lane is saturated. The control circuitry monitors the value in each lane of the processing apparatus and, when the value in the processing lane saturates, the control circuitry is configured to disable that processing lane such that further operations involving that processing element are not performed. The value in the processing lane can be any value that is present in the processing lane. In some configurations the value is a value of an input element of an input register in the processing lane. In other configurations the value is a value of an output element of an output register of a preceding operation of the processing lane.

In some configurations the one or more predetermined conditions comprises a negative condition, and the control circuitry is configured to modify the per-lane mask in response to the processing state of the processing lane indicating that a value in the processing lane is negative. The control circuitry monitors the value in each lane of the processing apparatus and, when the value in the processing lane becomes negative, the control circuitry is configured to disable that processing lane such that further operations involving that processing element are not performed. The value in the processing lane can be any value that is present in the processing lane. In some configurations the value is a value of an input element of an input register in the processing lane. In other configurations the value is a value of an output element of an output register of a preceding operation of the processing lane.

In some configurations the one or more predetermined conditions comprises a divide-by-zero condition, and the control circuitry is configured to modify the per-lane mask in response to the processing state of the processing lane indicating that a value in the processing lane is divided by zero. The control circuitry monitors the value in each lane of the processing apparatus and, when the value in the processing lane indicates that a divide by zero operation has occurred, for example, because the value in the processing lane is indicative of a NaN (Not a Number) value, the control circuitry is configured to disable that processing lane such that further operations involving that processing element are not performed. The value in the processing lane can be any value that is present in the processing lane. In some configurations the value is a value of an input element of an input register in the processing lane. In other configurations the value is a value of an output element of an output register of a preceding operation of the processing lane.

In some configurations the one or more predetermined conditions comprises a numerical condition specifying a number, and the control circuitry is configured to modify the per-lane mask in response to the processing state of the processing lane indicating that a value in the processing lane is equal to the number. The control circuitry monitors the value in each lane of the processing apparatus and, when the value in the processing lane becomes equal to the number, the control circuitry is configured to disable that processing lane such that further operations involving that processing element are not performed. The value in the processing lane can be any value that is present in the processing lane. In some configurations the value is a value of an input element of an input register in the processing lane. In other configurations the value is a value of an output element of an output register of a preceding operation of the processing lane. In some configurations the control circuitry is provided with storage circuitry to store the number. In other configurations the storage circuitry is used to store a pointer to a location in which the number is stored.

In some configurations the processing apparatus further comprises a plurality of data input channels configured to receive data associated with the data processing operations; and the one or more predetermined conditions comprises a data condition specifying a data input channel of the plurality of data input channels, and the control circuitry is configured to modify the per-lane mask in response to the processing state of the processing lane indicating that data in the input channel associated with the processing lane is marked as invalid. In this way the control circuitry can be arranged to control the processing circuitry to perform operations only in lanes of the plurality of processing lanes for which there is data available. In some configurations, in which the processing apparatus is arranged as a triggered processing apparatus, the data condition can be used to prioritise between triggered instructions such that priority is given to the instruction for which the greatest amount of data is available, thereby resulting in a greater throughput of instructions.

Whilst the per-lane mask is controlled by the control circuitry in response to the processing state of each of the processing lanes. In some configurations the decode circuitry is responsive to a set-mask instruction specifying a new per-lane mask to generate set-mask control signals; and the processing circuitry is configured, in response to the set-mask control signals, to set the new per-lane mask as the per-lane mask. The new per-lane mask can be specified as an immediate value or by specifying a register, or portion of a register, storing the new per-lane mask. This approach allows the programmer to specify the per-lane mask in order to provide the programmer with control as to which lanes of the plurality of processing lanes are enabled. For example, the programmer could choose to enable all of the processing lanes of the plurality of processing lanes. In some configurations the decoder circuitry is responsive to the set-mask instruction to cause the control circuitry to pause monitoring of each processing lane of the plurality of processing lanes. In other configurations, the set-mask instruction sets an initial per-lane mask that is then altered by the control circuitry based on the processing state of each processing lane.

In some configurations the decode circuitry is responsive to a reset-condition instruction to generate reset-condition control signals; and the processing circuitry is configured, in response to the reset-condition control signals to set the predetermined condition to a default predetermined condition. The default predetermined condition can be any of the previously described conditions. In some configurations the default predetermined condition is a null condition and, when the default predetermined condition is set, the control circuitry is configured to maintain a current value of the per-lane mask independent of a processing state of each of the plurality of processing lanes.

In some configurations the per-lane mask is a single implicit predicate and the processing circuitry is configured to reference the implicit predicate for all instructions of the plurality of instructions that perform processing in the plurality of processing lanes. The single implicit predicate is therefore used to determine which lanes of the plurality of processing lanes are enabled and which lanes of the plurality of processing lanes are disabled for each operation that is performed by the processing circuitry. In alternative configurations the per-lane mask is one of a plurality of implicit predicates and the processing circuitry is configured to reference one of the plurality of implicit predicates dependent on a type of the instruction. For each instruction that is executed by the processing circuitry, the processing circuitry accesses the implicit predicate of the plurality of implicit predicates that is associated with that type of instruction. In this way the programmer can control different types of instruction using different predicates.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, System Verilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and System Verilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

Particular configurations of the present techniques will now be described with reference to the accompanying figures.

FIG. 1 schematically illustrates a processing apparatus 10 according to various configurations of the present techniques. The processing apparatus 10 is provided with decoder circuitry 12, control circuitry 14 and processing circuitry 20. The decoder circuitry 12 is provided to decode instructions from an instruction set architecture to generate control signals that are used to control the processing circuitry 20. The processing circuitry 20 is provided with a plurality of processing lanes 24. In the illustrated configuration four processing lanes 24 are provided: processing lane 00 24(A), processing lane 01 24(B), processing lane 10 24(C), and processing lane 11 24(D). The control signals, that are provided by the decoder circuitry 12, control each lane 24 of the processing circuitry to perform a processing operation when that processing lane 24 is enabled. The control as to whether the processing lane is enabled is managed by the control circuitry 14. The control circuitry monitors the processing state of each of the processing lanes 24 and determines whether the lanes meet one or more predetermined conditions 18. Dependent on whether the processing state of each processing lane 24 meets the predetermined condition 18, the control circuitry 14 modifies a per-lane mask 16. In the illustrated example, the control circuitry 14 has determined that the processing lane 10 24(C) meets the predetermined condition 18 and has set the corresponding bit of the per-lane mask 16 to a zero to indicate that processing lane 10 should be disabled. The per-lane mask 16 is fed back to the processing circuitry and the switches 22 are used to control whether the corresponding processing lanes are enabled or are disabled. In the illustrated configuration, the per-lane mask 16 is set to 1101 indicating that processing lane 00 24(A), processing lane 01 24(B), and processing lane 11 24(D) are enabled; and that processing lane 10 24(C) is disabled. Hence, in response to the most significant (leftmost) bit of the per-lane mask 16 being set to a logical 1, the switch 22(A) is in an enabled state and the control signals, that were generated by the decoder circuitry 12, are used to control processing lane 00 24(A). In response to the next most significant bit (the second leftmost bit) of the per-lane mask 16 being set to a logical 1, the switch 22(B) is in the enabled state and the control signals, that were generated by the decoder circuitry 12, are used to control processing lane 01 24(B). In response to the next most significant bit (the third leftmost bit) of the per-lane mask 16 being set to a logical 0, the switch 22(C) is in a disabled state and the control signals, that were generated by the decoder circuitry 12, are withheld from the processing lane 10 24(C) and the processing lane 10 24(C) is disabled. Finally, in response to the least significant bit (the rightmost bit) of the per-lane mask 16 being set to a logical 1, the switch 22(D) is in the enabled state and the control signals, that were generated by the decoder circuitry 12, are used to control processing lane 11 24(D). The control circuitry 14 is arranged to monitor the processing circuitry continually and to modify the per-lane mask 16 if, at any point, the processing state of a processing lane 24 changes such that the predetermined condition 18 is met for that processing lane, then the control circuitry 14 is configured to modify the corresponding bit of the per-lane mask 16.

In some alternative configurations the number of processing lanes 24 in the processing apparatus 10 is larger than four. For example, the number of processing lanes 24 could be 8, 16, 32 or higher. In such configurations the per-lane mask is provided with more bits, one for each of the processing lanes and the control of whether the processing lanes are enabled or disabled is carried out as described in relation to the illustrated processing lanes. In some configurations, the control circuitry 14 forms part of the same block of circuitry as the processing circuitry 20.

FIG. 2 schematically illustrates the processing apparatus 10 according to various configurations of the present techniques. The functional components illustrated in FIG. 2 are the same as those illustrated in FIG. 1 and, for reasons of conciseness, the description of these components will not be repeated. FIG. 2 illustrates the response of the processing apparatus 10 to a set-mask instruction specifying a new value for the per-lane mask 16 and to an update-condition instruction specifying a new condition. In response to the set-mask instruction, the decoder circuitry 12 generates set-mask control signals which are passed to the control circuitry 14 via the processing circuitry 20. The control circuitry 14 is responsive to the set-mask control signals to modify the per-lane mask to the new per-lane mask specified in the set-mask instruction. In response to the update-condition instruction, the decoder circuitry 12 generates update-condition control signals which are passed to the control circuitry 14. The control circuitry 14 is configured, in response to the control signals issued by the decoder circuitry 14, to modify the predetermined condition 18 such that the control circuitry is responsive to the processing state of the processing lanes meeting the new condition to modify the per-lane mask. In some alternative configurations, the set-mask control signals and the update-condition control signals are passed directly from the decoder circuitry 12 to the control circuitry 14 without going via the processing circuitry.

FIG. 3 schematically illustrates a processing apparatus 30 arranged to operate as a triggered processing apparatus according to various configurations of the present techniques. The processing apparatus 30 is provided with front-end circuitry 36, decoder circuitry 38, processing circuitry 40 and control circuitry 46. The front-end circuitry 36 stores a plurality of retrieved instructions, each of which is associated with a trigger condition, and is arranged to generate triggered instructions when an execution state of the processing circuitry meets the trigger condition that is associated with one of the plurality of retrieved instructions. The front-end circuitry also comprises a plurality of input channels to retrieve data associated with the retrieved instructions. The triggered instructions are passed from the front end circuitry 36 to the decoder circuitry 38 which generates control signals to be passed the processing circuitry 40. The processing circuitry performs operations defined by the control signals using the plurality of processing lanes 44 which are enabled/disabled based on the per-lane mask 32. The per-lane mask 32 is continuously updated, by the control circuitry 46, based on a processing state of the individual processing lanes 44 meeting the predetermined condition 32. In this way, the choice of instruction to be executed is based on the execution state of the processing circuitry 40 as a whole and the per-lane execution of the operation is controlled, based on the processing state of each processing lane, by the per-lane mask 32. The per lane mask 32 is also fed back to the front-end circuitry 36. When the execution state of the processing circuitry 40 is such that multiple retrieved instructions are eligible to be passed to the decoder circuitry 38 as triggered instructions, the front-end circuitry 36 is configured to select which of the eligible instructions is to be used first (prioritised) to generate a triggered instruction. In some alternative configurations, the control circuitry is arranged to determine whether the predetermined condition 34 is met based on whether the input data received by the front-end processing circuitry 36 is marked as valid or invalid on a per-lane basis.

FIG. 4 schematically illustrates details of control circuitry 50 of a processing apparatus according to various configurations of the present techniques. The control circuitry 50 is configured to store a first per-lane mask 54 and a second per-lane mask 56 and is arranged to select which per-lane instruction mask is to be used based on a type of instruction that is being processed by the processing circuitry. The control circuitry 50 receives an indication of the instruction type which controls a switch 52 to select between the first per-lane mask 54 and the second per-lane mask 56. The control circuitry 50 is also configured to store a first predetermined condition 58 and a second predetermined condition 60. The processing state of each processing lane of the processing circuitry is compared to the first predetermined condition 58 and the second predetermined condition 60. Bits of the first per-lane mask 54 are set when the processing state of the corresponding processing lane meets the first predetermined condition 58 and bits of the second per lane mask 56 are set when the processing state of the corresponding processing lane meets the second predetermined condition 60. In this way, the processing state of a particular processing lane could be such that the first predetermined condition 58 is not met (as illustrated in the third least significant bit of the first per-lane mask 54) and the second predetermined condition 60 is met (as illustrated in the third least significant bit of the second per-lane mask 56). As a result, the third least significant processing lane will be enabled for instructions which are of a type associated with the second per-lane mask 56 and will be disabled for instructions which are of a type associated with the first per-lane mask 54.

FIG. 5 schematically illustrates processing apparatus 62 arranged as a spatial architecture according to various examples of the present techniques. Spatial architectures can accelerate some applications by unrolling or unfolding the computations, which form the most time-consuming portion of program execution, in space rather than in time. Computations are unrolled in space by using a plurality of hardware units capable of concurrent operation. In addition to taking advantage of the concurrency opportunities offered by disaggregated applications which have been spread out on a chip, spatial architectures, such as the processing apparatus 62, also take advantage of distributed on-chip memories. In this way, each processing element is associated with one or more memory blocks in close proximity to it. As a result, spatial architectures can circumvent the von-Neumann bottleneck which hinders performance of many traditional architectures.

The processing apparatus 62 comprises an array of processing elements which is connected to a cache hierarchy or main memory via interface nodes, which are otherwise referred to as interface tiles (ITs), and are connected to the network via multiplexers (X). Processing elements in the processing apparatuses 62 according to the configurations described herein comprise two different types of circuitry. Each processing element comprises processing circuitry, otherwise referred to as compute tiles (CTs), and memory control circuitry, otherwise referred to as memory tiles (MTs). The role of the CTs is to perform the bulk of the data processing operations and arithmetic computations. Each of the compute tiles within the processing elements of the processing apparatus 62 can be arranged as described in relation to FIGS. 1-4. The role of the MTs is to perform data accesses to locally connected memory (local storage circuitry) and data transfers to/from the more remote regions of memory and inter-processing element memory transfers between the processing element and other processing elements.

In some example configurations each of the processing elements of the processing apparatus 62 comprises local storage circuitry connected to each memory control circuit (MT) and each memory control circuitry (MT) has direct connections to one processing circuit (CT). Each MT-CT cluster is connected to a network-on-chip which is used to transfer data between memory control circuits (MTs) and between each memory control circuit (MT) and the interface node (IT). In alternative configurations local storage circuitry is provided between plural processing elements and is accessible by multiple memory control circuits (MTs). The processing elements may be conventional processing elements. Alternatively, the processing elements may be triggered processing elements in which an instruction is executed when a respective trigger condition or trigger conditions is/are met.

The processing elements of the data processing apparatus 62 illustrated in FIG. 5 are each connected via a set of input and output channels to the network-on-chip which comprises switches, and data links between those switches forming a two-dimensional torus topological layout. Data can be routed around the network-on-chip using any algorithm. However, a particularly efficient routing algorithm is the xy routing algorithm modified to take the torus layout into account. The xy algorithm prevents routing deadlocks (cyclic dependence between processing elements and/or network resources which makes forward progress impossible) within the network by prohibiting data routed along the y direction from being subsequently routed along the x direction.

FIG. 6 schematically illustrates further details of the operation of a processing apparatus according to various configurations of the present techniques when the processing apparatus is arranged as a triggered architecture. The processing element comprises a current execution state latch 70 to latch a current execution state of the processing circuitry, an instruction cache 72, 74 to store a sequence of instruction opcodes 72, associated with each of the plurality of retrieved instructions, with corresponding trigger conditions and next execution state information 74 indicative of the next execution state that the processing element will reach upon successful execution of the corresponding instruction. The processing element further comprises pre-decode circuitry 76 to perform an initial pre-decoding step to split the instructions stored in the instruction cache 72, 74 into micro-operations suitable for processing in processing lanes 80 of the processing circuitry 66. The processing element further comprises a next execution state latch 84 to store the next execution state that the processing circuitry will enter upon completion of the current instruction, and a completed latch 82 to latch an indication as to whether the instruction has been completed. The processing element comprises a switch (de-multiplexor) 86 to update the current execution state of the processing circuitry as stored in the current execution state latch 70 in response to the completion latch 82 indicating that the current instruction has completed. Together the current execution state latch 70, the instruction cache 72, 74, the pre-decode circuitry 76, the completed latch, and the next execution state latch form the front end circuitry responsible for generating triggered instructions based on a current execution state of the processing element. The processing element is also provided with control circuitry 64 which is arranged according to any of the configurations described herein. The control circuitry monitors the processing state of the processing lanes 80 and determines whether each of the processing lanes meet one or more predetermined conditions. The control circuitry 64 updates a per-lane mask in response to the processing state of the processing lanes which is fed back to the processing circuitry 80 to cause each of the processing lanes to be enabled or disabled. The control circuitry 64 also feeds the per-lane mask back to the instruction cache 72, 74 of the front-end circuitry which uses the per-lane mask to prioritise retrieved instructions when trigger conditions associated with two or more of the plurality of retrieved instructions are simultaneously met.

In operation the processing element determines an instruction, stored in the instruction cache 72, 74, to be the next triggered instruction based on the current execution state latched in the current execution state latch 70. If the current execution state latched in the current execution state latch 70 matches the trigger condition associated with an instruction stored in the instruction cache 72, 74 then that instruction is passed to the pre-decode circuitry 76 to be broken into micro-operations which are, in turn, passed to the decode circuitry 78 as triggered instructions. In addition, the instruction cache 72, 74 determines a corresponding next execution state 74 that is associated with the instruction for which the trigger condition is met. The next execution state 74 is passed to the next execution state latch 84. At this point the instruction is not complete and, hence, the completion latch stores an indication that this is the case. The current execution state latch 70 is not updated with the next execution state stored in the next execution state latch 84. Instead, the current execution state that is stored in the current execution state latch 70 is fed back, via the switch 86, to the input of the current execution state latch 70 and, in this way, the current execution state latch is maintained with the current execution state. The triggered instructions are passed to the decode circuitry 78 which generates control signals to cause the processing lanes 80, for which the per-lane mask stored in the control circuitry indicates that the corresponding processing lane is enabled, to perform processing operations based on the triggered instructions. When the processing operations are completed, an indication that the processing operations are completed is stored in the completion latch. Outputs from the processing lanes 80 may be used to update the next execution state based on the operations carried out during processing and a processing state of each of the processing lanes 80 is monitored by the control circuitry 64. Once the processing element has latched, in the completion latch 82, that the processing has completed, the current execution state latch is updated to contain the value that was previously latched in the next execution state latch. The new current execution state, that is latched in the current execution state latch 70, can then be used by the processing element to determine a next instruction to be used to generate a triggered instruction.

FIGS. 7a and 7b schematically illustrate values of the predetermined condition and the per-lane mask before and after execution of an instruction in response to a sequence of instructions. The instructions will be described sequentially from the first instruction at the top of each of the figures to the final instruction at the bottom of each of the figures.

Starting with FIG. 7a, the first instruction that is received is a “listener SAT” instruction. The “listener” instruction is an update-condition instruction that causes the processing apparatus to update the predetermined condition to a saturation condition. The control circuitry is responsive to this instruction to set the predetermined condition to the saturation condition. It is assumed that, for the illustrated example, the per-lane mask before this instruction is received is [1,1,1,1] indicating that each lane of the plurality of processing lanes is enabled. The values in the processing lanes after the instruction, which are indicative of a value of vector vecJ as determined by a preceding instruction in this case, are [−124,2,2,−64]. The “listener SAT” instruction updates the predetermined condition but has no effect on the value in the processing lanes or the per-lane mask after the instruction is executed.

The next instruction to be executed is a saturating addition operation “qadd vecJ, vecJ, vecS” where vecS is already defined (for example, by a previous instruction) to be “vecS=[126,126,126,126]”. This instruction adds the value of vecS to vecJ and stores the output in vecJ. Because qadd is a saturating addition, the output will not exceed the saturation value and instead will saturate to the maximum value that can be stored in vecJ. The per lane mask after the “listener SAT” instruction was set to [1,1,1,1]. Hence, each processing lane of the plurality of processing lanes is enabled and the saturating addition operation is carried out for each lane. The values in the processing lanes are assumed to saturate at a value of 127. Hence, the values in the processing lanes after the instruction is vecJ=[2,127,127,62]. Because the second and third least significant elements of vecJ have saturated, the control circuitry automatically sets the per-lane mask after the instruction to [1,0,0,1].

The next instruction to be executed is a second saturating addition operation “qadd vecJ, vecJ, vecS” where vecS is already defined (for example, by a previous instruction) to be “vecS=[126,126,126, 126]”. This instruction adds the value of vecS to vecJ and stores the output in vecJ. Because qadd is a saturating addition, the output will not exceed the saturation value and instead will saturate to the maximum value that can be stored in vecJ. The per lane mask after the “listener SAT” instruction was set to [1,0,0,1]. Hence, the most significant processing lane and the least significant processing lane of the plurality of processing lanes are enabled and the saturating addition operation is carried out for these lanes. The second and third least significant processing lanes are disabled and processing is therefore not carried out in these lanes. The values in the processing lanes are assumed to saturate at a value of 127. Hence, the values in the processing lanes after the instruction is vecJ=[127,127,127, 127]. Because each of the elements of vecJ have saturated, the control circuitry automatically sets the per-lane mask after the instruction to [0,0,0,0].

The next instructions to be issued are a “reset-condition” instruction that resets the predetermined condition to a default predetermined condition, and a “set per-lane mask [1,1,1,1] instruction that sets the value of the per-lane mask to [1,1,1,1]. The value of vecJ is not changed in response to these instructions which instead cause the predetermined condition to be reset and the per-lane mask to be updated.

The next instruction is a “listener value, 64” instruction which updates the one or more predetermined conditions such that the predetermined condition is satisfied when the value of vecJ in the processing lane is set to 64. Because none of the values in the processing lanes are set to 64, the per-lane mask remains unmodified and has a value of [1,1,1,1] after the “listener value, 64” instruction is executed.

The next instruction is another saturating addition operation “qadd vecJ, vecJ, vecS” where vecS is already defined (for example, by previous instruction) to be “vecS=[−63,−64,−65,−66]”. This instruction adds the value of vecS to vecJ and stores the output in vecJ. Because qadd is a saturating addition, the output will not exceed the saturation value and instead will saturate to the maximum value that can be stored in vecJ. The per lane mask after the “listener value, 64” instruction was set to [1,1,1,1]. Hence, each lane of the plurality of processing lanes is enabled and the saturating addition operation is carried out for all the lanes. The values in the processing lanes after the instruction is vecJ=[64,63,62,61]. Because the most significant element of vecJ is equal to 64, the control circuitry automatically sets the per-lane mask after the instruction to [0,1,1,1].

The next instruction is another saturating addition operation “qadd vecJ, vecJ, vecS” where vecS is already defined (for example, by previous instruction) to be “vecS=[1,1,1,1]”. This instruction adds the value of vecS to vecJ and stores the output in vecJ. Because qadd is a saturating addition, the output will not exceed the saturation value and instead will saturate to the maximum value that can be stored in vecJ. The per lane mask after the preceding “qadd vecJ, vecJ, vecS” instruction was set to [0,1,1,1]. Hence, the three least significant (rightmost) lanes of the plurality of processing lanes are enabled and the saturating addition operation is carried out for these lanes. The most significant (leftmost) lane of the plurality of processing lanes is disabled because the per-lane mask indicates that the predetermined condition has already been met for this lane. The values in the processing lanes after the instruction is vecJ-[64,64,63,62]. Because the two most significant elements of vecJ are equal to 64, the control circuitry automatically sets the per-lane mask after the instruction to [0,0,1,1].

The next instruction is another saturating addition operation “qadd vecJ, vecJ, vecS” where vecS is already defined (for example, by previous instruction) to be “vecS=[1,1,1,1]”. This instruction adds the value of vecS to vecJ and stores the output in vecJ. Because qadd is a saturating addition, the output will not exceed the saturation value and instead will saturate to the maximum value that can be stored in vecJ. The per lane mask after the preceding “qadd vecJ, vecJ, vecS” instruction was set to [0,0,1,1]. Hence, the two least significant (rightmost) lanes of the plurality of processing lanes are enabled and the saturating addition operation is carried out for these lanes. The two most significant (leftmost) lanes of the plurality of processing lanes are disabled because the per-lane mask indicates that the predetermined condition has already been met for these lanes. The values in the processing lanes after the instruction is vecJ=[64,64,64,63]. Because the three most significant elements of vecJ are equal to 64, the control circuitry automatically sets the per-lane mask after the instruction to [0,0,0,1].

The stream of instructions continues on FIG. 7b where the first instructions are a “reset-condition” instruction that sets the predetermined condition to the default condition; and a “listener div0” instruction which sets the predetermined condition to the div0 condition. Hence, the control circuitry ceases monitoring for the value being equal to 64 and, instead, monitors for an indication that a divide by zero has occurred. The values in the processing lanes are not modified by the “listener div0” operation. However, the per-lane mask is now set based on whether or not the value in the processing lanes after the instruction meets the divide by zero condition. The values in the processing lanes after the instruction are [64,64,64,63], none of which indicate that a divide by zero has occurred. Hence, the value of the per-lane mask after the instruction is [1,1,1,1].

The next instruction is a “sdiv vecJ, vecJ, vecS” instruction where vecS is already defined (for example, by previous instruction) to be “vecS=[4,2,1,0]”. The sdiv instruction causes each element of vector vecJ to be divided by the corresponding element of vector vecS and the result to be stored in the vector vecJ. The per lane mask after the preceding “listener div0” instruction was set to [1,1,1,1]. Hence, all of the lanes of the plurality of processing lanes are enabled and the division operation is carried out for all of the lanes. The values in the processing lanes after the instruction is vecJ=[16,32,64,NaN] (where NaN is a value indicative that the result is not a number because a divide by zero has occurred). The control circuitry is configured, in response to the divide by zero, to set the per-lane mask after the instruction to [1,1,1,0].

The next instruction is a “set per-lane mask [1,1,1,1]” instruction. The purpose of this instruction is to set a current value of the per-lane mask, in this case to [1,1,1,1]. However, because the control circuitry is still monitoring for a case in which a divide by zero error has occurred, the control circuitry sets the per-lane mask to [1,1,1,0] such that the “set per-lane mask” instruction has no effect on the per-lane mask.

The next instruction is another “sdiv vecJ, vecJ, vecS” instruction where vecS is already defined (for example, by previous instruction) to be “vecS=[2,1,0,−1]”. The sdiv instruction causes each element of vector vecJ to be divided by the corresponding element of vector vecS and the result to be stored in the vector vecJ. The per lane mask after the preceding “set per-lane mask [1,1,1,1]” instruction was set to [1,1,1,0]. Hence, the three most significant (leftmost) lanes of the plurality of processing lanes are enabled and the division operation is carried out for these lanes. The least significant (rightmost) lane of the plurality of processing lanes is disabled and no division operation is carried out in this lane. The values in the processing lanes after the instruction is vecJ=[8,32,NaN,NaN] (where NaN is a value indicative that the result is not a number because a divide by zero has occurred). The control circuitry is configured, in response to the divide by zero, to set the per-lane mask after the instruction to [1,1,0,0].

The next instruction is a “listener negative” instruction which adds a new condition to the predetermined condition. In this case, the condition is a negative condition which causes the control circuitry to monitor for negative values in the processing lanes in addition to monitoring for the divide by zero operation. Because the “listener negative” instruction has not modified the values in the processing lanes and none of the processing lanes contains a negative value, the per-lane mask after the instruction remains as [1,1,0,0].

The final instruction is a “qadd vecJ, vecJ, vecJ, vecS” instruction where vecS is already defined (for example, by a previous instruction) to be “vecS=[−128,−128,−128,−128]”. The per lane mask after the preceding “listener negative” instruction was set to [1,1,0,0]. Hence, the two most significant (leftmost) lanes of the plurality of processing lanes are enabled and the division operation is carried out for these lanes. The least significant (rightmost) two lanes of the plurality of processing lanes are disabled and no division operation is carried out in these lanes. The values in the processing lanes after the instruction is vecJ=[−120,−96,NaN,NaN] (where NaN is a value indicative that the result is not a number because a divide by zero has occurred). The control circuitry is configured, in response to the divide by zero in the two least significant (rightmost) lanes and the negative values in the two most significant (leftmost) lanes, to set the per-lane mask after the instruction to [0,0,0,0].

The preceding example instructions are provided to schematically illustrate the operation of the control circuitry to enable/disable processing lanes of the processing circuitry in response to a processing state of that processing lanes. It would be readily apparent to the skilled person that alternative instructions could be provided in a different order and that the control circuitry would monitor the processing state of the processing lanes to determine which lanes of the plurality of processing lanes are to be enabled/disabled.

FIG. 8 schematically illustrates a sequence of steps carried out by the control circuitry according to various configurations of the present techniques. Flow begins at step S800 where the control circuitry waits for the next instruction cycle. At the next instruction cycle flow proceeds to step S802 where the control circuitry begins the process of determining whether the predetermined condition is met for each of the lanes. At step S802 a variable j is set equal to zero. The variable j is used as a counter to step through each of the lanes sequentially. Flow then proceeds to step S804 where it is determined whether the predetermined condition is met on lane j. If the predetermined condition is met on lane j then flow proceeds to step S806 where the j-th bit of the per-lane mask is set to indicate that the predetermined condition is met. Flow then proceeds to step S808. If however, at step S804, it was determined that the predetermined condition was not met for lane j then flow proceeds to step S812 where the j-th bit of the per-lane mask is set to indicate that the predetermined condition is not met. Flow then proceeds to step S808. At step S808 it is determined whether there are any more lanes to test. If, at step S808, it is determined that there are no more lanes to test then flow returns to step S800. If however, at step S808, it is determined that there are more lanes to be tested, then the variable j is incremented and flow returns to step S804. The process of determining whether the predetermined condition is met is illustrated sequentially. However, the process of determining whether the predetermined condition is met or not could, in alternative configurations, be carried out in parallel for each of the lanes.

FIG. 9 schematically illustrates a sequence of steps carried out by the processing apparatus according to various configurations of the present techniques. Flow begins at step S900 where it is determined whether an instruction has been received or not. If no instruction has been received then flow remains at step S900. If, at step S900, it is determined that an instruction has been received then flow proceeds to step S902. At step S902 the decoder circuitry generates control signals in response to the instruction that has been received. Flow then proceeds to step S904 where the processing circuitry performs a processing operation in a plurality of processing lanes for which a per-lane mask indicates that processing is enabled. The processing operation is not performed in processing lanes for which the per-lane mask indicates that processing is disabled. Flow then proceeds to step S906 where the control circuitry monitors the processing state of the processing lanes. Flow then proceeds to step S908 where the control circuitry updates the per-lane mask to indicate which processing lanes of the plurality of processing lanes meet one or more predetermined conditions. Flow then returns to step S900.

FIG. 10 schematically illustrates the fabrication of a processing apparatus according to various configurations of the present techniques. Fabrication is carried out based on computer readable code 1002 that is stored on a non-transitory computer-readable medium 1000. The computer-readable code can be used at one or more stages of a semiconductor design and fabrication process, including an electronic design automation (EDA) stage, to fabricate an integrated circuit comprising the apparatus embodying the concepts. The fabrication process involves the application of the computer readable code 1002 either directly into one or more programmable hardware units such as a field programmable gate array (FPGA) to configure the FPGA to embody the configurations described hereinabove or to facilitate the fabrication of an apparatus implemented as one or more integrated circuits or otherwise that embody the configurations described hereinabove. The fabricated design 1004 is the processing apparatus 10, comprising the decoder circuitry 12, processing circuitry 20, and control circuitry 14 as described in reference to FIG. 1. In alternative configurations, the computer readable code 1002 stored on the non-transitory computer-readable medium 1000 can be arranged to store information used to facilitate the fabrication of the processing apparatus according to the described configurations.

In brief overall summary there is provided a processing apparatus comprising decoder circuitry. The decoder circuitry is configured to generate control signals in response to an instruction. The processing apparatus further comprises processing circuitry which comprising a plurality of processing lanes. The processing circuitry is configured, in response to the control signals, to perform a vector processing operation in each processing lane of the plurality of processing lanes for which a per-lane mask indicates that processing for that processing lane is enabled. The processing apparatus further comprises control circuitry to monitor each processing lane of the plurality of processing lanes for each instruction of a plurality of instructions performed in the plurality of processing lanes and to modify the per-lane mask for a processing lane of the plurality of processing lanes in response to a processing state of the processing lane meeting one or more predetermined conditions.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative configurations have been described in detail herein with reference to the accompanying drawings, it is to be understood that the invention is not limited to those precise configurations, and that various changes, additions and modifications can be effected therein by one skilled in the art without departing from the scope and spirit of the invention as defined by the appended claims. For example, various combinations of the features of the dependent claims could be made with the features of the independent claims without departing from the scope of the present invention.

1. A processing apparatus comprising:
decoder circuitry configured to generate control signals in response to an instruction;
processing circuitry comprising a plurality of processing lanes, wherein the processing circuitry is configured, in response to the control signals, to perform a vector processing operation in each processing lane of the plurality of processing lanes for which a per-lane mask indicates that processing for that processing lane is enabled; and
control circuitry to monitor each processing lane of the plurality of processing lanes for each instruction of a plurality of instructions performed in the plurality of processing lanes and to modify the per-lane mask for a processing lane of the plurality of processing lanes in response to a processing state of the processing lane meeting one or more predetermined conditions.

2. The processing apparatus of claim 1, wherein:
the instruction is a triggered instruction; and
the processing apparatus is a triggered processing apparatus comprising frontend circuitry to process a plurality of retrieved instructions and to generate the triggered instruction in response to an execution state of the processing circuitry meeting a trigger condition associated with one of the plurality of retrieved instructions.

3. The processing apparatus of claim 2, wherein the front-end circuitry is configured, in response to a determination that two or more retrieved instructions of the plurality of retrieved instructions meet a trigger condition at a given time, to determine a priority order of the two or more retrieved instructions based on a number of enabled processing lanes associated with each of the two or more retrieved instructions.

4. The processing apparatus of claim 3, wherein the front-end circuitry is configured to determine the priority order based on a length of time for which the trigger condition of the two or more retrieved instructions has been satisfied.

5. The processing apparatus of claim 1, wherein:
the processing apparatus comprises a plurality of processing elements arranged to form a spatial architecture; and
the decoder circuitry, the control circuitry, and the processing circuitry are arranged in a processing element of the plurality of processing elements.

6. The processing apparatus of claim 5, wherein the plurality of processing elements are connected via a two dimensional network arranged as a two-dimensional torus.

7. The processing apparatus of claim 1, wherein:
the decoder circuitry is responsive to an update-condition instruction specifying a new condition to generate update-condition control signals; and
the processing circuitry is configured, in response to the update-condition control signals, to set the new condition as one of the one or more predetermined conditions.

8. The processing apparatus of claim 1, wherein the control circuitry is configured to modify the per-lane mask in order to meet an energy consumption target.

9. The processing apparatus of claim 1, wherein the one or more predetermined conditions comprises a saturation condition, and the control circuitry is configured to modify the per-lane mask in response to the processing state of the processing lane indicating that a value in the processing lane is saturated.

10. The processing apparatus of claim 1, wherein the one or more predetermined conditions comprises a negative condition, and the control circuitry is configured to modify the per-lane mask in response to the processing state of the processing lane indicating that a value in the processing lane is negative.

11. The processing apparatus of claim 1, wherein the one or more predetermined conditions comprises a divide-by-zero condition, and the control circuitry is configured to modify the per-lane mask in response to the processing state of the processing lane indicating that a value in the processing lane is divided by zero.

12. The processing apparatus of claim 1, wherein the one or more predetermined conditions comprises a numerical condition specifying a number, and the control circuitry is configured to modify the per-lane mask in response to the processing state of the processing lane indicating that a value in the processing lane is equal to the number.

13. The processing apparatus of claim 1, further comprising a plurality of data input channels configured to receive data associated with the data processing operations; and
the one or more predetermined conditions comprises a data condition specifying a data input channel of the plurality of data input channels, and the control circuitry is configured to modify the per-lane mask in response to the processing state of the processing lane indicating that data in the input channel associated with the processing lane is marked as invalid.

14. The processing apparatus of claim 1, wherein:
the decode circuitry is responsive to a set-mask instruction specifying a new per-lane mask to generate set-mask control signals; and
the processing circuitry is configured, in response to the set-mask control signals, to set the new per-lane mask as the per-lane mask.

15. The processing apparatus of claim 1, wherein:
the decode circuitry is responsive to a reset-condition instruction to generate reset-condition control signals; and
the processing circuitry is configured, in response to the reset-condition control signals to set the predetermined condition to a default predetermined condition.

16. The processing apparatus of claim 1, wherein the per-lane mask is a single implicit predicate and the processing circuitry is configured to reference the implicit predicate for all instructions of the plurality of instructions that perform processing in the plurality of processing lanes.

17. The processing apparatus of claim 1, wherein the per-lane mask is one of a plurality of implicit predicates and the processing circuitry is configured to reference one of the plurality of implicit predicates dependent on a type of the instruction.

18. A method of operating a processing apparatus comprising processing circuitry comprising a plurality of processing lanes, the method comprising: generating control signals in response to an instruction; performing, in response to the control signals, a vector processing operation using the processing circuitry in each processing lane of the plurality of processing lanes for which a per-lane mask indicates that processing for that processing lane is enabled; and monitoring each processing lane of the plurality of processing lanes for each instruction of a plurality of instructions performed in the plurality of processing lanes and to modify the per-lane mask for a processing lane of the plurality of processing lanes in response to a processing state of the processing lane meeting one or more predetermined conditions.

19. A non-transitory computer-readable medium to store computer-readable code for fabrication of a processing apparatus comprising: decoder circuitry configured, in response to an instruction, to generate control signals; processing circuitry comprising a plurality of processing lanes, wherein the processing circuitry is configured, in response to the control signals, to perform a vector processing operation in each processing lane of the plurality of processing lanes for which a per-lane mask indicates that processing for that processing lane is enabled; and control circuitry to monitor each processing lane of the plurality of processing lanes for each instruction of a plurality of instructions performed in the plurality of processing lanes and to modify the per-lane mask for a processing lane of the plurality of processing lanes in response to a processing state of the processing lane meeting one or more predetermined conditions.
